(19) United States
(12) Patent Application Publication
(10) Pub. No.: US 2013/0155081 A1
(43) Pub. Date: Jun. 20, 2013

(54) POWER MANAGEMENT IN MULTIPLE PROCESSOR SYSTEM

(71) Applicants: Oleksandr Khodorkovsky, Toronto (CA); Stephen Presant, San Jose, CA (US)

(72) Inventors: Oleksandr Khodorkovsky, Toronto (CA); Stephen Presant, San Jose, CA (US)

(73) Assignees: ATI TECHNOLOGIES ULC, Markham (CA); ADVANCED MICRO DEVICES, INC., Sunnyvale, CA (US)

(21) Appl. No.: 13/327,266

(22) Filed: Dec. 15, 2011

(51) Int. Cl. G06F 1/32; G06T 1/00

(52) U.S. Cl. 345/522

(57) ABSTRACT

Power management for a processing system that has multiple processing units, (e.g., multiple graphics processing units (GPUs), is described herein. The processing system includes a power manager that obtains performance, power, operational or environmental data from a power management unit associated with each processor (e.g., GPU). The power manager determines, for example, an average value with respect to at least one of the performance, power, operational or environmental data. If the average value is below a predetermined threshold for a predetermined amount of time, then the power manager notifies a configuration manager to alter the number of active processors (e.g., GPUs), if possible. The power may then be distributed among the remaining GPUs or other processors, if beneficial for the operating and environmental conditions.

### FIELD OF INVENTION

This application is related to graphics processing.

### BACKGROUND

Computer systems may have multiple processors, such as multiple central processing units (CPUs) or multiple graphics processing units (GPUs) or other processor types. A notebook, for example, may have a graphics processing system which may include multiple GPUs working together for collaborative rendering. A graphics-intensive application or game may run that requires, or may benefit from having, additional processing power provided by using multiple GPUs. The multiple GPUs may provide performance gains through parallel processing of graphics tasks, for example. Decisions on whether multiple GPUs should be used are nominally based on formal rules or application profiles that were created in advance by running the application against a reference system. For example, formal rules may include that while on AC power supply, maximize performance using all available GPU's, and in contrast while on battery supply, minimize energy consumption by using only one GPU. Another formal rule may include using multiple GPUs for all unknown full-screen 3D applications. Some applications will have inter-GPU dependencies, and the required communication overhead diminishes the benefit of using multiple GPUs. Both approaches are static and do not account for actual dynamic operating conditions, which may result in processor usage inefficiencies.

In one example, some applications, relative to other applications, may require more CPU and GPU power. The sum of the power budgets for all of the processors may exceed the system power budget. If the application or mix of applications does create a maximum load on all processors, the frequency and voltage settings of the CPUs and GPUs may have to be scaled down, which results in performance which is lower than it would be when using fewer GPUs with higher performance settings.

In another example, some systems may have a lower performance CPU that is unable to utilize all the processing power of the GPUs. Dynamic power management features typically available in GPUs may scale down the frequency and voltage settings of the GPUs to reduce power consumption. However, it can still be higher than the power consumption of fewer GPUs running at a higher frequency and producing the same resulting performance.

### SUMMARY OF EMBODIMENTS OF THE INVENTION

Power management for a processing system that has multiple processing units, (e.g., multiple graphics processing units (GPUs), is described herein. The processing system includes a power manager that obtains performance, power, operational or environmental data from a power management unit associated with each processor (e.g., GPU). The power manager determines, for example, an average value with respect to at least one of the performance, power, operational or environmental data. If the average value is below a predetermined threshold for a predetermined amount of time, then the power manager notifies a configuration manager to alter the number of active processors (e.g., GPUs), if possible. The power may then be distributed among the remaining GPUs or other processors, if beneficial for the operating and environmental conditions.

In an exemplary embodiment, a system for managing power includes a configuration manager that dispatches tasks to at least one active processor. The system further includes a power management unit that monitors performance of the at least one active processor and a power manager that receives at least one performance measurement from the power management unit. The power manager notifies the configuration manager to adjust the configuration of at least one portion of the at least one active processor in response to the at least one performance measurement, where adjusting the configuration of the at least one portion of the at least one active processor alters task dispatches to the at least one active processor.

### BRIEF DESCRIPTION OF THE DRAWINGS

A more detailed understanding may be had from the following description, given by way of example in conjunction with the accompanying drawings, wherein:

FIG. 1 is a block diagram of an example processing system with multiple graphics processing units (GPUs);

FIG. 2 is a block diagram of an example processing system with a power manager and power management unit;

FIG. 3 is a block diagram of an example power management unit;

FIG. 4 is an example power management flowchart;

FIG. 5 is an example power management flowchart for reducing the number of GPUs; and

FIG. 6 is a block diagram of an example device in which one or more disclosed embodiments may be implemented.

### DETAILED DESCRIPTION OF THE EMBODIMENTS

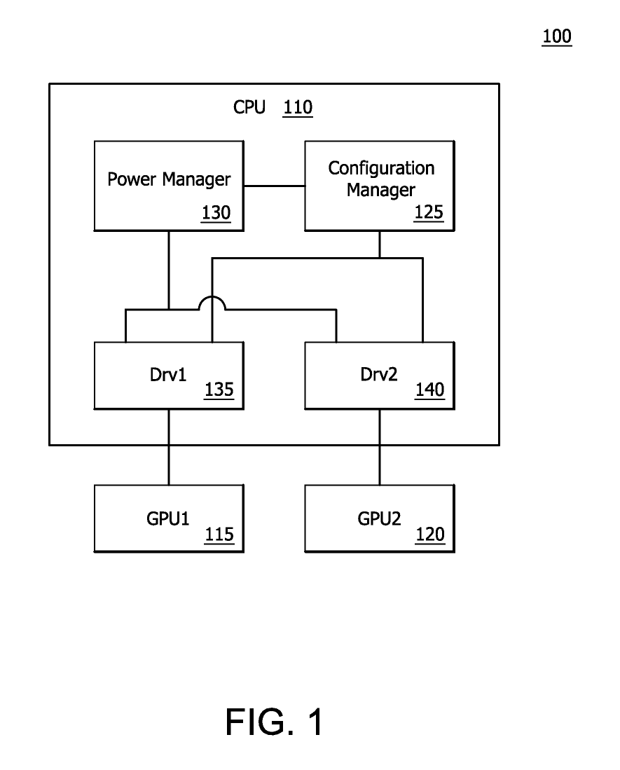

FIG. 1 is a block diagram of a processing system 100 that may include a central processing unit (CPU) 110 that may be connected to two graphics processing units (GPUs), GPU1 115 and GPU2 120. The CPU 110 may be a processor adapted to execute instructions of the x86 instruction set. Other chip and instruction sets may also be used. Although a single CPU is shown, CPU 110 may represent one or more CPUs. As would be understood by those skilled in the art, GPU1 115 and GPU2 120 may be used to perform a variety of graphics tasks such as rendering and driving a display. Although two GPUs are shown, GPU1 115 and GPU2 120 may represent multiple GPUs or other types of processors.

The CPU 110 may include a configuration manager 125 connected to a power manager 130. The configuration manager 125 and power manager 130 are each connected to driver 135 and driver 140, respectively. The drivers 135 and 140 are in turn connected to GPU1 115 and GPU2 120, respectively. The drivers 135 and 140 may comprise instances of a program running on the CPU 110 that handles operations specific to GPU1 115 and GPU2 120, respectively. In an embodiment, the drivers 135 and 140 control the operation of GPU1 115 and GPU2 120, respectively. In general, the number of drivers may correspond to the number of the GPUs in the system 100.

The configuration manager 125 receives information about applications launched on the system 100. The configuration manager 125 may dispatch graphics tasks to GPU(s) based on information associated with each task.

As described herein below, the power manager 130 monitors system power events, such as power source, (including battery charge status), power policy changes, GPU power, and thermal status, and controls the power state configuration of each GPU. When the configuration manager 125 makes a decision to use a particular GPU, it requests power manager 130 to bring the GPU into operating mode. If the current system thermal and power conditions allow using this GPU, power manager 130 switches the operating mode of the particular GPU. Otherwise the power manager 130 reports back to the configuration manager 125 that the GPU is currently unavailable.

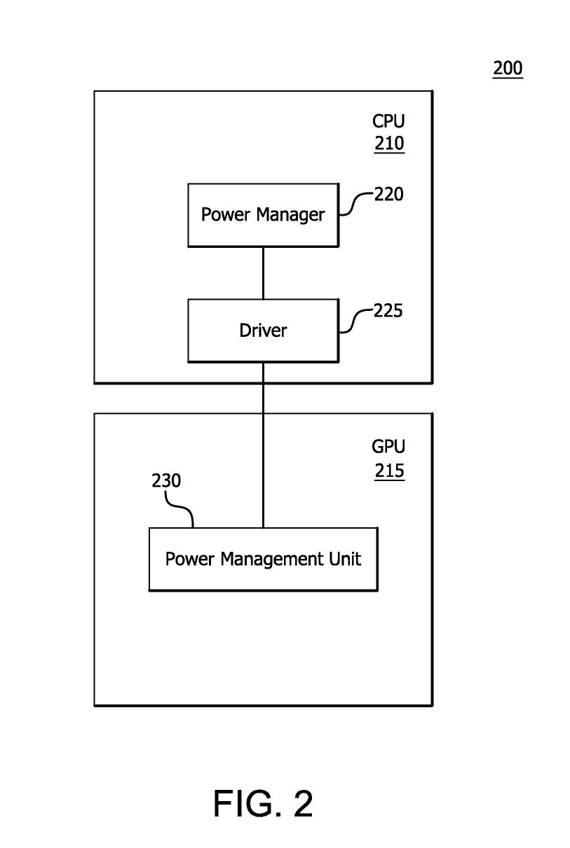

FIG. 2 is a block diagram of a processing system 200 that shows an example power management structure between a central processing unit (CPU) 210 and a graphics processing unit (GPU) 215. The CPU 210 may include a power manager 220 connected to a driver 225, which in turn is connected to a power management unit 230 of the GPU 215. The power manager 220 monitors GPU 215 parameters, for example power, performance and operating data, by communicating with the power management unit 230.

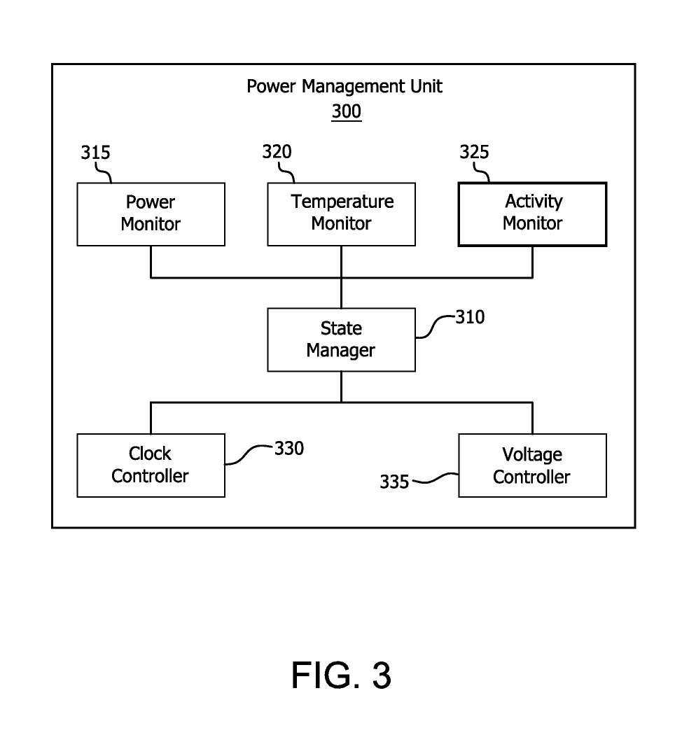

FIG. 3 is a block diagram of a power management unit 300. The power management unit 300 monitors and collects data related to the GPU. The power management unit 300 may monitor GPU activity level, power consumption and temperature and may use this data to control GPU clock frequencies and voltages. Other power consumption parameters that can be adjusted on a processor may also be monitored and collected. For example, a processor (e.g., GPU) might enable the monitoring and collecting of data related to various power islands within the processor, operation of various functional units within a power island (e.g., the number and depth of graphic pipelines within a GPU), width and operation of memory controllers and the like. The power management unit 300 may collect the data and determine long and short term average value(s) for the data or information. The average values may be used by the power manager to determine a course of action with respect to the GPU. Other statistics may also or be alternatively be generated. For example, most frequent configuration, high and/or low watermarks associated with various parameters, weighted averages, median values and the like.

As a non-limiting example, the power management unit 300 may include a state manager 310 that communicates with a power monitor 315, temperature monitor 320 and an activity and performance monitor 325. The power monitor 315, temperature monitor 320 and activity monitor 325 may transmit or send specific parameter information to the state manager 310. The power monitor 315, for example, may provide data concerning a power condition of the device, (e.g., generally, what type of power source is currently being employed; in a battery powered device, the rate at which the battery is discharging or the amount of stored charge left; or in an AC powered device, the rate at which power is being consumed). The temperature monitor 320, for example, may provide the temperature of the power source and other components. The activity monitor 325, for example, may determine and send an activity level based on a degree of activity (or idleness) of multiple device components or processors.

The state manager 310 also communicates with a clock controller 330 and voltage controller 335. In particular, the state manager 310 controls operating frequency and operating voltage based on processor (e.g., GPU) utilization level, power consumption and temperature. The power monitor 315, temperature monitor 320, and activity monitor 325 may be embedded circuits or mechanisms in the GPU. GPU subsystems and memory interfaces may thus be monitored independently to more accurately assess effective GPU utilization.

Referring both to FIGS. 2 and 3, in one embodiment, the power manager 220 may obtain data or information from the power management unit 230 via the driver 225. The driver 225 may access memory mapped registers associated with the power monitor 315, temperature monitor 320, activity monitor 325, clock controller 330 and voltage controller 335. In another embodiment, the driver 225 may send messages on behalf of the power manager 220 to the state manager 310 and request the data or information as mentioned above.

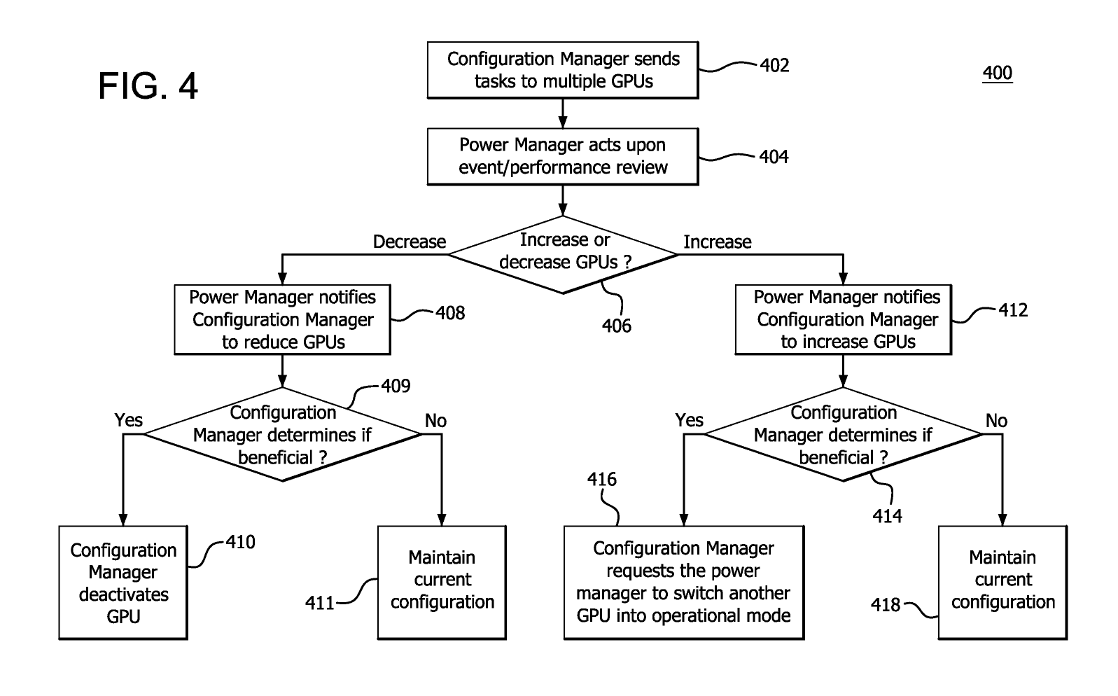

FIG. 4 is an example power management flowchart 400 with reference to FIG. 1. A configuration manager 125 may determine that an application may benefit from using multiple processors (e.g., GPUs) and may dispatch graphics tasks to the selected processors (e.g., GPU(s) (402)). On the occurrence of a power or thermal event and/or a performance evaluation, a power manager 130 may evaluate how the event affects the current processor (e.g., GPU) configuration (404). The power manager 130 may determine if the number of processors (e.g., GPUs) or various components/functional blocks therein may need to be reduced or whether it may be increased (406), i.e., the overall performance and/or capabilities is adjusted, upwards or downwards, through the adjustment of the current processor (e.g., GPU) configuration. The power manager 130 may notify the configuration manager if the number of processors (e.g., GPUs) or components therein (e.g., functional blocks or functional block configurations) has to be reduced (408). The configuration manager 125 may decide whether active application(s) may benefit from processor (e.g., GPU) reduction (409). The configuration manager 125 may request the power manager to reduce the number of active processors (e.g., GPUs) (410). The configuration manager 125 may make a decision which processor (e.g., GPU) to exclude, stop dispatching tasks to the particular processor (e.g., GPU) and notify the power manager that the processor (e.g., GPU) may be switched into sub-operational state or turned off to save power. The remaining processors (e.g., GPUs) and other processors, for example CPUs, may now be run with higher performance settings. Otherwise, the current configuration is unchanged (411).

The power manager 130 may notify the configuration manager 125 if the number of processors (e.g., GPUs) may be increased (412). For example, this may occur due to a change in power source or power budget change. The configuration manager 125 may decide whether active application(s) may benefit from running on more processors (e.g., GPUs) (414). The configuration manager 125 may request the power manager 130 to switch another processor (e.g., GPU) into operational mode (416). Otherwise, the current configuration is unchanged (418).

In another example, the power manager 130 may request urgent action from the configuration manager 125 without a re-evaluation, i.e., a benefit analysis.

In another example, a timer or counter may filter how often the configuration manager 125 is notified that a configuration change may be needed. There is a power overhead for each reconfiguration and this may control the number of reconfigurations in a given period and therefore control power consumption. This may provide a mechanism of avoiding thrashing between two or more configurations. The timer/counter configuration may to some extent manage the maximum frequency that the system may thrash between configurations. For example, if the number of performance or power events of a particular event type is counted, then after a given number of such event types, a reconfiguration may be triggered. The timer or counter may be reset after the given number of event types and the current configuration has been re-evaluated and adjusted, as appropriate. In another example, the timer or counter may be reset after the occurrence of a different type of performance or power event, (as a way to reduce configuration thrashing (i.e., frequent configuration changes)). Other hysteresis arrangements may be employed to reduce such thrashing between configurations.

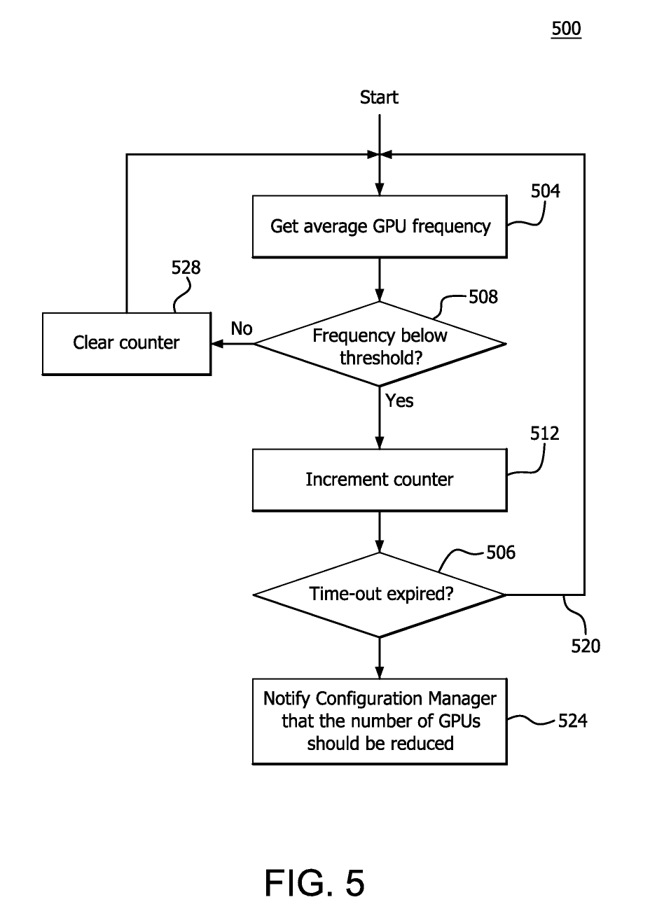

FIG. 5 is an example power management flowchart 500 for determining whether a processor (e.g., GPU) reduction may be needed. In an initial state or as a base assumption, a configuration manager may determine that an application may benefit from using multiple processors (e.g., GPUs) and may dispatch graphics tasks to multiple processors (e.g., GPUs) for execution. Given this state or assumption, a power management unit may adjust the frequency for each of the multiple processors (e.g., GPUs) based on operating conditions and power and thermal limitations (504). An average frequency may be used as an indicator to the driver of how the processor (e.g., GPU) is running given power, task level, activity level and other like factors. The frequency may be the operating frequency of the memory, graphics rendering engine, audio/video encoding engines, audio/video decoding engines, or other dedicated multimedia or parallel processing engines controlled by a power management unit or other like components. Although frequency is described herein, other indicators of processor (e.g., GPU) performance may also be used such as performance counters within the processor (e.g., GPU), rendered frames per second and sustained giga-FLOPs, (billions of floating point operations per second).

The power manager obtains the average frequency number from the power management unit and determines if the average frequency is below a predetermined or given threshold (508). If the processor (e.g., GPU) frequency is below the threshold, a time counter is incremented or a timer is turned on if it is not already on (512). The time counter or timer may be used to determine how long the processor (e.g., GPU) frequency has been below the threshold. The power manager then determines if the time counter has reached a predetermined or given number or the timer has timed out (516). If the time counter is below the predetermined or given number or the timer has not timed out, then the power manager repeats the process and obtains new average frequencies (520). If the time counter has reached or exceeded the predetermined or given number or the timer has timed out, then the power manager notifies the configuration manager that the number of processors (e.g., GPUs) needs to be reduced (524). If the processor (e.g., GPU) frequency is above the threshold, then the time counter is cleared or the timer is turned off (528).

If the number of processors (e.g., GPUs) may have been reduced as described herein above, the number of active processors (e.g., GPUs) may be restored in response to some events, such as power source change or power budget change. In one embodiment, the processors (e.g., GPUs) may also be restored if after a scheduled review, the workload created by the application may have changed and may now benefit from using more processors (e.g., GPUs).

In one example, total performance may be used to determine whether processors (e.g., GPUs) may be decreased or increased. If the utilization levels of all the processors (e.g., GPUs) are below a threshold, the number of processors (e.g., GPUs) may be gradually reduced. Utilization of the processors (e.g., GPUs), memory interfaces and the like may be monitored as described herein above. If the total utilization increases, then additional processors (e.g., GPUs) may be added.

In another example, total power consumption may be used to shut down one or more processors (e.g., GPUs) to save power or enable the power to be used more effectively by other system components. If the total power consumption exceeds, for example, the thermal design power (TDP) or thermal design current (TDC), and all processors (e.g., GPUs) settings are scaled down to system limits, the number of active processors (e.g., GPUs) may be reduced to achieve similar performance with less power or higher performance with similar power. The TDP and TDC may represent a measure of the power budget and other measures may also be used.

In another example, a combination of operating conditions may initiate a reduction in the number of active processors (e.g., GPUs). If, for example, at least one processor (e.g., GPU) exceeded power limit and its operating settings were reduced, it may impede task scheduling between active processors (e.g., GPUs) by causing delays. The delays may stall task scheduling between the processors (e.g., GPUs) and reduce the average activity of other processors (e.g., GPUs). Their frequency settings may be reduced due to lower processor (e.g., GPU) utilization, which in turn may exacerbate total system performance.

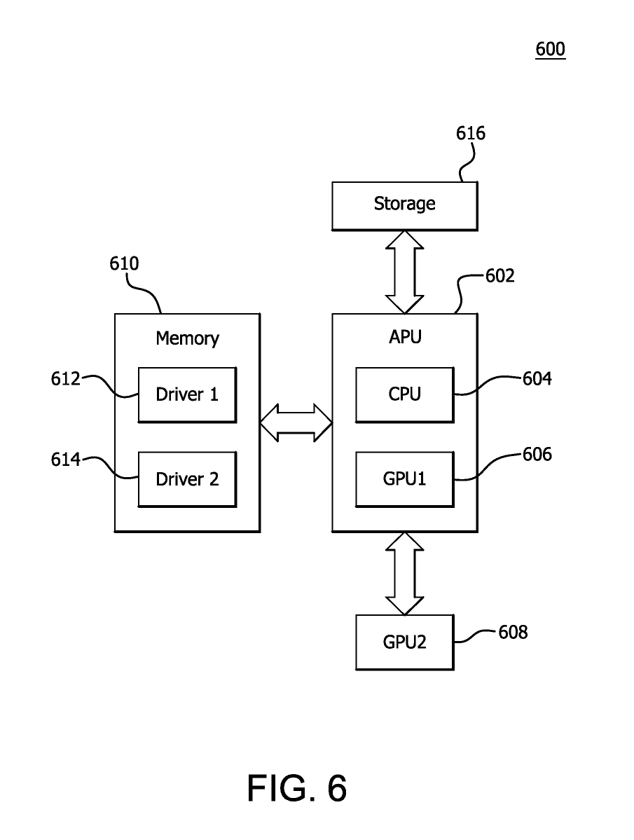

FIG. 6 is a block diagram of an example device 600 in which one or more disclosed examples or embodiments may be implemented. The device 600 may be, for example, a desktop computer, a notebook, or a gaming device. The device 600 includes an accelerated processor unit (APU) 602, one or more graphics processing units (GPU) 608, a memory 610, and a storage 606. It is understood that the device may include additional components not shown in FIG. 6.

The APU 602 may include one or more cores of central processing unit (CPU) 604, and one or more cores of graphics processing unit (GPU) 606 located on the same die. The memory 610 may be located on the same die as the processor 602, or may be located separately from the processor. The memory 610 may include a volatile or non-volatile memory, for example, random access memory (RAM), dynamic RAM, or a cache.

The storage 616 may include a fixed or removable storage, for example, hard disk drive, solid state drive, optical disk, or flash drive.

During execution, the memory 610 stores the driver 612 that controls the internal GPU 606 and the driver 614 that controls the external GPU 608. The driver 612 communicates with the CPU 604 and the internal GPU 606. The driver 614 communicates with the CPU 604 and the external GPU 608.

Described herein are example scenarios using the methods and apparatus described hereinabove. In one multiple processor (e.g., GPU) scenario, the configuration manager may determine that it is better to run more or less processors (e.g., GPUs) based on performance metrics. For example, a performance metric for running one processor (e.g., GPU) may be x. If two processors (e.g., GPUs) are being used, the performance metric may be 1.8x and not 2x due to overhead and synchronization. Therefore, if you are running two processors (e.g., GPUs) at half speed, it is equivalent to a performance metric of 0.9x, and running one processor (e.g., GPU) may be more efficient. The power saved from shutting down the extra processor (e.g., GPU) may be shifted to other components.

In another example scenario, a notebook, laptop or other mobile computing platform may operate on A/C or DC. If the mobile computing platform is operating off of a DC source, then the processors (e.g., GPUs) may be scaled down to stay within the power budget of the DC source. In a related example scenario, the mobile computing platform may use a standard A/C adapter or a travel adapter, where the travel adapter may not operate at 100% efficiency as compared to the standard adapter. In this instance, the processors (e.g., GPUs) may be scaled down to stay within the power budget or efficiency of the travel adapter. Both of these examples may be indicators of a change in the power budget or power source.

In another example scenario, the CPU may not have sufficient tasks for the multiple processors (e.g., GPUs) and as a result, the processors (e.g., GPUs) may only be partially running in terms of performance. This may lead to scaled down operating frequencies for the processors (e.g., GPUs) or reducing the number of active processors (e.g., GPUs).

The methods and apparatus use a performance metric to decrease the number of processors (e.g., GPUs), either by shutting down the processor (e.g., GPU) or placing it in sub-operational mode. For example, sub-operational mode may mean substantially reducing the operating frequencies of the processor (e.g., GPU), setting the operating voltage of the processor (e.g., GPU) just high enough to maintain the reduced operating frequencies, completely shutting down circuit blocks such as phase-locked loops (PLLs) and input/output pads, disabling memory accesses, switching memory to self-refresh, and placing the processor (e.g., GPU) in low power standby mode. The power may then be used by other components. For instance, when processors, (e.g., CPU or GPU), are consuming less power there is an implicit opportunity for other active processors to consume more power when the platform is limited by platform wide constraints. An increase in the number of processors (e.g., GPUs) may be event driven. These events may include but are not limited to a change in the power budget, change in the power source or timing out of a timer. For example, a mobile system may have additional processor (e.g., GPU) resources available when connected to a docking station. The process of docking or undocking may also be used as trigger events to force re-configuration.

In an example, a method for managing power in a system includes receiving at least one performance measurement from a power management unit of at least one active processor and notifying a configuration manager to adjust the configuration of at least one portion of the at least one active processor in response to the at least one performance measurement from the power management unit. The adjusting of the configuration of the at least one portion of the at least one active processor alters task dispatches to the at least one active processor. The configuration adjustment may permit re-distribution of power in the system. A system capability determination may be made to adjust configuration of the at least one portion of the at least one active processor in response to the at least one performance measurement. Moreover, the configuration adjustment may be made to the at least one portion of the at least one active processor based on performance benefits. A timer or other method may be used to control the frequency of configuration changes.

In another example, a system for managing power includes a configuration manager configured to assign tasks to at least one active processor. The system also includes a power management unit that monitors performance of the at least one active processor and a power manager that receives at least one performance measurement from the power management unit. The power manager notifies the configuration manager to adjust the configuration of at least one portion of the at least one active processor in response to the at least one performance measurement. The adjusting of the configuration of the at least one portion of the at least one active processor alters task dispatches to the at least one active processor.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Although features and elements are described above in particular combinations, each feature or element may be used alone without the other features and elements or in various combinations with or without other features and elements. The methods provided may be implemented in a general purpose computer, a processor or any IC that utilizes power gating functionality. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be mask works that are then used in a semiconductor manufacturing process to manufacture a processor which implements aspects of the present invention.

What is claimed is:

1. A method for managing power, comprising:
receiving at least one performance measurement from a power management unit of at least one active processor; and
notifying a configuration manager to adjust the configuration of at least one portion of the at least one active processor in response to the at least one performance measurement from the power management unit, wherein adjusting the configuration of the at least one portion of the at least one active processor alters task dispatches to the at least one active processor.

2. The method of claim 1, wherein adjusting the configuration alters number of active processors and re-distributes power to a new number of active processors in response to a power performance measurement.

3. The method of claim 1, further comprising:
determining capability to adjust configuration of the at least one portion of the at least one active processor in response to the at least one performance measurement; and
notifying the configuration manager that the at least one portion of the at least one active processor may be adjusted based on performance benefits.

4. The method of claim 1, wherein the at least one performance measurement is at least one of operating frequency, operating voltage, operating current, power, activity level, and thermal conditions.

5. The method of claim 1, further comprising:
initiating a timer in response to the at least one performance measurement to control frequency of configuration changes.

6. The method of claim 1, further comprising:
determining a statistic using at least the at least one performance measurement.

7. The method of claim 1, further comprising:
re-distributing power in response to adjusting the configuration of the at least one portion of the at least one active processor.

8. A system for managing power, comprising:
a configuration manager configured to assign tasks to at least one active processor;
a power management unit configured to monitor performance of the at least one active processor;
a power manager configured to receive at least one performance measurement from the power management unit; and
the power manager configured to notify the configuration manager to adjust the configuration of at least one portion of the at least one active processor in response to the at least one performance measurement, wherein adjusting the configuration of the at least one portion of the at least one active processor alters task dispatches to the at least one active processor.

9. The system of claim 8, wherein adjusting the configuration alters number of active processors and re-distributes power to a new number of active processors in response to a power performance measurement.

10. The system of claim 8, further comprising:
the power manager configured to determine system capability to adjust configuration of the at least one portion of the at least one active processor in response to the at least one performance measurement; and
the power manager configured to notify the configuration manager that the at least one portion of the at least one active processor may be adjusted based on performance benefits.

11. The system of claim 8, wherein the at least one performance measurement is at least one of operating frequency, operating voltage, operating current, power, activity level, and thermal conditions.

12. The system of claim 8, further comprising:
the power manager configured to initiate a timer in response to the at least one performance measurement to control frequency of configuration changes.

13. The system of claim 8, further comprising:
the power manager configured to determine a statistic using at least the at least one performance measurement.

14. The system of claim 8, further comprising:
the configuration manager configured to re-distribute power in response to adjusting the configuration of the at least one portion of the at least one active processor.

15. A method for managing power, comprising:
receiving at least one performance measurement from a power management unit of at least one active processor;
counting number of reconfigurable events with respect to the at least one performance measurement; and
notifying a configuration manager to adjust the configuration of at least one portion of the at least one active processor on a condition that the counter has reached a given value, wherein adjusting the configuration of the at least one portion of the at least one active processor alters task dispatches to the at least one active processor.

16. The method of claim 15, wherein adjusting the configuration alters number of active processors and re-distributes power to new number of active processors in response to a power performance measurement.

17. The method of claim 15, further comprising:
determining capability to adjust configuration of the at least one portion of the at least one active processor in response to the at least one performance measurement; and
notifying the configuration manager that the at least one portion of the at least one active processor may be adjusted based on performance benefits.

18. The method of claim 15, wherein the at least one performance measurement is at least one of operating frequency, operating voltage, operating current, power, activity level, and thermal conditions.

19. The method of claim 15, further comprising:
resetting a counter on a condition that the number of reconfigurable events has reached the given value.

20. The method of claim 15, further comprising:
resetting a counter on a condition that a reconfigurable event has occurred for at least another performance measurement.

21. The method of claim 15, further comprising:
re-distributing power in response to adjusting the configuration of the at least one portion of the at least one active processor.

22. A computer readable media including hardware design code stored thereon, and when processed generates other intermediary data to create one or more mask works for a processor configured to perform a method of managing power, comprising:
receiving at least one performance measurement from a power management unit of at least one active processor; and
notifying a configuration manager to adjust the configuration of at least one portion of the at least one active processor in response to the at least one performance measurement from the power management unit, wherein adjusting the configuration of the at least one portion of the at least one active processor alters task dispatches to the at least one active processor.

23. A computer readable media including hardware design code stored thereon, and when processed generates other intermediary data to create one or more mask works for a processor configured to perform a method of managing power, comprising:
receiving at least one performance measurement from a power management unit of at least one active processor;
counting number of reconfigurable events with respect to the at least one performance measurement; and
notifying a configuration manager to adjust the configuration of at least one portion of the at least one active processor on a condition that the counter has reached a given value, wherein adjusting the configuration of the at least one portion of the at least one active processor alters task dispatches to the at least one active processor.
